(19) United States
(12) Patent Application Publication
(10) Pub. No.: US 2005/0013288 A1
(43) Pub. Date: Jan. 20, 2005

(54) System and method for dynamically load balancing traffic in a wireless network

(75) Inventors: Hilton Hong, San Jose, CA (US); Sherman Shih, Cupertino, CA (US); Liegh Michael Chinitz, Wellesley, MA (US)

Correspondence Address: Robert E. Krebs;Thelen Reid & Priest, LLP, P.O. Box 640640, San Jose, CA, 95164-0640, US

(73) Assignee: Proxim Corporation, a Delaware Corporation

(21) Appl. No.: 10/765,561

(22) Filed: Jan. 26, 2004

Related U.S. Application Data
(60) Provisional application No. 60/443,138, filed on Jan. 27, 2003.

(51) Int. Cl. H04L 12/66

(52) U.S. Cl. 370/352

(57) ABSTRACT

A device for wirelessly transmitting data under a wireless protocol is contemplated. The device contains a first circuit that receives or transmits data packets from or to a remote wireless device. The device also contains a second circuit that receives or transmits data packets from or to a first device through a network connection. A third circuit is used to determine a load factor for the device. The load factor is based, at least in part, on the latency of a data packet in moving between the remote wireless device and the first device.

This application claims priority based on provisional application Ser. No. 60/443,138, entitled “System and Method for Dynamically Load Balancing Traffic in a Wireless Network” by Hilton Hung filed on Jan. 27, 2003.

### FIELD OF THE INVENTION

The present invention relates to a wireless communication system. More particularly, the present invention is related to balancing load traffic to and from access point in a wireless data transfer.

### BACKGROUND

In some wireless networks, an access point (AP) can be coupled to a variety of wireless network devices. When a particular wired network device attempts to connect to a network through an access point, the access point may give an indication of the efficiency of that access point to transfer information between the wireless network device and the rest of the network. In this manner, some wireless protocols, such as those based on an 802.11 wireless standards, allow the access point to transmit a load factor.

The load factor is meant to be an indication to the wireless network device of the ability of the particular access point to transmit information in an efficient manner. Some access points have load factors based on a variety of factors.

In some cases, the load factor is derived from the number of devices coupled to the access point. However, when one access point has a small number of active users and another has a large number of inactive users, this may not be indicative of the efficiency of the access point.

Other ways in which the load factor may be derived is based on a number of packets sent. However, this may not be indicative of the true state of the access point as well. Consider the case in which one user is involved in pulling down 100 packets per second, with each packet being 3000 bytes. If another machine shows 1000 packets per second, with the size of the packets being only 100 bytes long, the number of packets is not indicative of the workload of the access points in question.

### SUMMARY

A device for wirelessly transmitting data under a wireless protocol is contemplated. The device contains a first circuit that receives or transmits data packets from or to a remote wireless device. The device also contains a second circuit that receives or transmits data packets from or to a first device through a network connection. A third circuit is used to determine a load factor for the device. The load factor is based, at least in part, on the latency of a data packet in moving between the remote wireless device and the first device.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a network diagram of a wireless network with a dynamically operable load balancing scheme, according to the invention.

FIG. 2 is a time diagram showing how an exemplary latency used in the derivation of the load factor is determined.

### DETAILED DESCRIPTION

Embodiments of the present invention are described herein in the context of a System And Method For Dynamically Load Balancing Traffic In A Wireless Network. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of digital systems, including hardware, software, or any combination thereof. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

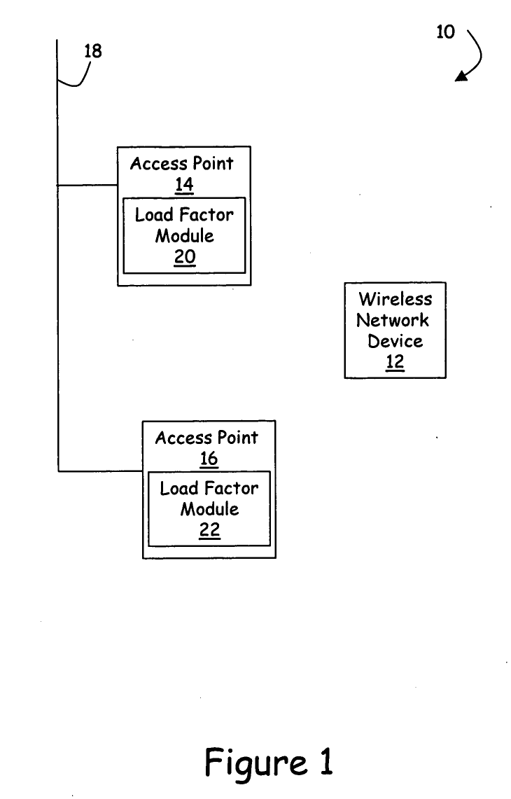

FIG. 1 is a network diagram of a wireless network with a dynamically operable load balancing scheme, according to the invention. A wireless network 10 contains a wireless network device 12, an access point 14, and an access point 16. The access points 14 and 16 are coupled to a wired network 18. The access point 14 has a latency load factor determination portion 20, and the access point 16 has a latency load factor determination portion 22.

The wireless protocol in the described example is one running under the 802.11 protocol. However, this specification should be read to include any wireless protocol implementing a load factor.

At some time, the wireless network device 12 comes into contact with the access points 14 and 16. The wireless network device 12 attempts to make a network connection to the wired network 18. In doing so, the wireless network device 14 receives at some point an indication of the load factor present on both the access points 14 and 16.

Based upon the value of the load factor or some other value derived from the load factor, the wireless network device 12 couples to the wired network 18 through a particular access point. In the terms of this specification, the load factor is derived from the latency of the particular access point. In some cases, the latency is a general latency, but the latency may be specific to particular types of communications as well.

It should be noted that this operates when the access points 14 and 16 are coupled to different wired networks, or to other wireless nodes in a bridging fashion. In the terms of the specification, the access points 14 and 16 may be coupled to any variety of wired or wireless networks, and the access points 14 and 16 may or may not be directly coupled, as shown in FIG. 1.

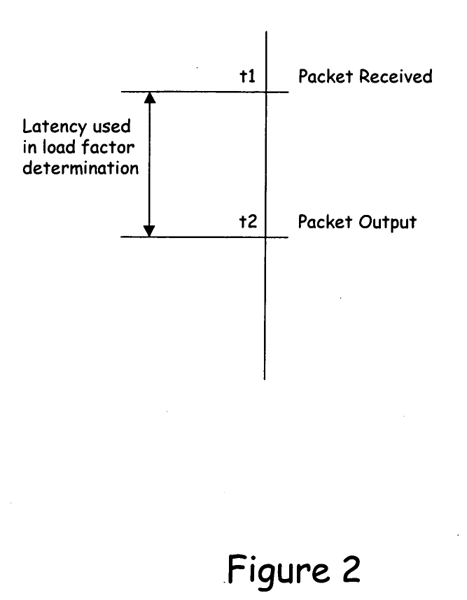

FIG. 2 is a time diagram showing how an exemplary latency used in the derivation of the load factor is determined. At a time t1, a packet is received by a particular access point for processing and delivery to another device, such as the wireless network device 12. At the time t1, the access point determines the time that the packet is initially received, and makes a record of such time. This record may be internal to the access point, or may be a timestamp in the particular packet. In the case of time-stamping the packet, the packet may also be marked with another data field indicating that the particular packet is being timed.

At a later time t2, the access point outputs the packet to a destination. At the time the packet is sent, the access point compares the output time t2 with the input time t1 to derive a total latency for the packet trip. The latency of the packet is then indicative of the load factor of the access point.

The load factor may be the last latency, or may be derived with the use of a latency or series of latencies. In some embodiments, the load factor may be a weighted average of the last N latencies, a simple average of the last N latencies, or any number of statistical or probabilistic formulations based on any one or any group of latencies in the history.

Any number of methods may be used to select the particular packet being timed. This includes selecting every Nth packet for timing, selecting a packet based on elapsed time since the last selected packet, selecting a packet based on elapsed amount of data since the last selected packet, and so forth. As can be shown, many types of packet selection may be employed in the scope of the specification.

Additionally, the packets may be discriminated further. For example, the latency may be differentiated on the basis of data transmission type. In this case, a separate load factor may be calculated based on the amount of data per packet, on the differing protocol employed (i.e. file transfer protocol (FTP) vs. universal data protocol (UDP) transmissions, and the like.)

If an access point is capable of operating under multiple protocols (i.e. 802.11b, 802.11g), a different load factor may be generated for each protocol employed. Accordingly, a load factor based on latency may be employed for many differing factors, and a requesting wireless network device may ask for the load factor based on as general or as specific as the situation warrants.

Of course, the latency may be used with or without reference to other factors. For example, an indication may be based on a combination of a particular latency coupled with a number of attached users. Thus, the latency load factor can be used in whole or in part in the determination of an overall load factor.

Other variations may be contemplated as well. These variations include the use of the priority of the particular wireless network device in the determination of load balancing. FIG. 1 can also be used in the description of the load balance based on priorities. Assume that the access points 14 and 16 can assign or track priorities with a prioritization section.

At some time, the wireless network device 12 comes into contact with the access points 14 and 16. The wireless network device 12 attempts to make a network connection to the network 18. In doing so, the wireless network device 14 receives at some point an indication of the load factor present on both the access points 14 and 16. At the same time, the wireless network device conveys, or is assigned, some priority level that it can operate with respect to the AP through which it communicates with the network 10.

Each of the access points 14 and 16 maintain a load factor associated with a wireless device using the particular AP. Further, each of the access points 14 and 16 maintains multiple load factors, each load factor associated with a particular priority level usage.

Based upon the value of the load factor at the specified priority level, or some other value derived from the load factor at the priority level, the wireless network device 12 couples to the wired network 18 through a particular access point. The AP 14 maintains a priority load factor table, and the AP 16 maintains a similar priority load factor table. When the wireless network device 12 attempts to couple to the associated network, both the AP 14 and the AP 16 relay to the wireless network device 12 a load factor associated with a particular priority level.

In the first case, assume that the wireless network device 12 has or is assigned a priority level of 1, associated with the highest priority possible. In this case, the AP 14 sends a load factor of 7, and the AP 16 sends a load factor of 900. Assuming that the higher number refers to a higher load factor, the wireless network device 12 would then couple to the network using the AP 14.

In another example, assume that the wireless network device 12 has or is assigned a priority level of 3, associated with a medium priority possible. In this case, the AP 14 sends a load factor of 1500, and the AP 16 sends a load factor of 15. Assuming that the higher number refers to a higher load factor, the wireless network device 12 would then couple to the network using the AP 16.

Of course, other implementations may be envisioned. The wireless network device 12 may send a request for a combination of the lowest load factor with a specified minimum or maximum priority level. In this case, the AP sends a combination of priority level and load factor that meets the criteria. For example, if the wireless network device 12 were to send a request for the lowest load factor between levels 2 and 4, the AP sends back the lowest load factor value for the range along with the associated priority level.

Let us assume that the particular AP assigns priorities, rather than taking requests for them. In this case, the wireless network device would request a load factor based upon the highest priority it could obtain at the particular AP.

Thus, a System And Method For Dynamically Load Balancing Traffic In A Wireless Network is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A device for transmitting data wirelessly, the transmission of the data operating under a wireless protocol;
a first circuit for receiving or transmitting data packets from or to a remote wireless device;
a second circuit for receiving or transmitting data packets from or to a first device through a network connection; and
a third circuit for determining a load factor, wherein the load factor is based at least in part on the latency of a data packet in moving between the remote wireless device and the first device.

2. A device for transmitting data wirelessly, the transmission of the data operating under a wireless protocol, the device comprising:
a first circuit for receiving or transmitting data packets from or to a remote wireless device;
a second circuit for receiving or transmitting data packets from or to a first device through a network connection;
a third circuit for determining a load factor;
wherein the load factor is based at least in part on the latency of a data packet in moving between the remote wireless device and the first device; and
the device relaying the load factor to the remote device through the first circuit upon receiving an indication from the remote wireless device.

3. A method for determining a load factor for a device associated with a wireless network, the method comprising:
selectively determining to measure a latency associated with a particular incoming packet;
upon selectively determining to measure a latency, performing the steps of:
determining a first time associated with the arrival of the incoming packet from a first network device;
determining a second time associated with the sending of the incoming packet to a second network device;
determining a first value associated with the first time and the second time, the value to be sent to other wireless network devices as an indication of the network load of the device.

4. A device for transmitting data wirelessly, the transmission of the data operating under a wireless protocol, the device comprising:
first means for receiving or transmitting data packets from or to a remote wireless device;
first means for receiving or transmitting data packets from or to a first device through a network connection;
means for determining a load factor;
wherein the load factor is based at least in part on the latency of a data packet in moving between the remote wireless device and the first device; and
the device relaying the load factor to the remote wireless device upon receiving an indication from the remote wireless device.
